(19) United States
(12) Patent Application Publication
(10) Pub. No.: US 2021/0094241 A1
(43) Pub. Date: Apr. 1, 2021

(54) METHOD OF BUTT SEAMING ARTIFICIAL TURF AND RECYCLABLE BUTT SEAMED ARTIFICIAL TURF

(71) Applicant: Larry E. Mashburn, Dalton, GA (US)

(72) Inventor: Larry E. Mashburn, Dalton, GA (US)

(21) Appl. No.: 17/029,676

(22) Filed: Sep. 23, 2020

Related U.S. Application Data
(60) Provisional application No. 62/906,327, filed on Sep. 26, 2019.

(51) Int. Cl. B29C 65/00; B29C 65/10; B29C 65/50

(52) U.S. Cl. CPC B29C 66/1142; B29C 65/103; B29L 2007/008; B29C 65/5028; B29C 66/71

(57) ABSTRACT

The invention comprises a method of butt seaming artificial turf. The method comprises providing a piece of artificial turf comprising a primary backing material having an upper surface and a lower surface, a plurality of tufts of filament material formed in the primary backing material, wherein the tufts are arranged to simulate blades of grass extending outwardly from the upper surface of the primary backing material and the tufts have tuft backs formed on the lower surface of the primary backing material and a layer of a thermoplastic polymer formed on the lower surface of the primary backing material and the tuft backs such that the layer of thermoplastic polymer attaches the tuft backs to the primary backing material. The method further comprises heating a portion of the layer of thermoplastic polymer adjacent an edge of the artificial turf until the portion of the layer of thermoplastic polymer softens and pressing the softened portion of the layer of thermoplastic polymer into contact with a seaming tape.

### CROSS REFERENCE TO RELATED APPLICATION

The present application claims the benefit of the filing date of provisional application Ser. No. 62/906,327 filed Sep. 26, 2019.

### FIELD OF THE INVENTION

The present invention generally relates to artificial turf. More particularly, the present invention relates to a method of seaming artificial turf. Specifically, the present invention relates to a method of butt seaming artificial turf so that the finished product is recyclable.

### BACKGROUND OF THE INVENTION

Artificial turf is typically constructed from a primary backing material and a face pile formed on one side. Face pile can be formed in the primary backing by tufting a yarn in the primary backing. Currently, the majority of artificial turf manufactured in the U.S. is made by a tufting process. The tufting process forms cut pile on one side of a primary backing and loop backs on the opposite side by a process well known in the art. The primary backing can be made from a woven or nonwoven fabric of synthetic materials. Typically, the primary backing of a artificial turf is tufted with multiple strands that form a tufted fiber bundle.

After the primary backing is tufted, an adhesive precoat may be applied to lock or bind the tuft bundles in the primary backing. Typically, the adhesive precoat is a thermoset polyurethane polymer or an aqueous polymer dispersion, such as a styrene butadiene aqueous polymer dispersion. The thermoset polyurethane polymer or aqueous polymer dispersion-coated primary backing is then heated to initiate polyurethane polymerization or to remove the water from the aqueous polymer dispersion such that the polymer locks or binds the tuft loops in the primary backing. Then, a secondary backing may optionally be adhesively attached by applying a coating of adhesive on the side of the primary backing opposite the face pile. Such adhesive is typically a polyurethane, a latex or a hot melt adhesive. Then, a secondary backing is brought into intimate contact with the polymerizing polyurethane, uncured latex or the molten hot melt adhesive. The adhesive is then allowed to cool or cure, thereby adhesively attaching the secondary backing to the tufted primary backing.

When artificial turf is installed, for example on a football field, strips of artificial turf and placed transversely on the playing field. In order to make a unitary turf, adjacent strips of artificial turf are butt seamed together. There are many methods of seaming artificial turf. Adjacent strips of artificial turf can be sewn together; however, this is a labor-intensive process. Another method of seaming artificial turf is to use a seaming tape placed under adjacent strips of artificial turf at the butt seam. The seaming tape has a hot melt adhesive disposed on the surface of the seaming tape adjacent the under surface of the artificial turf. The holt met adhesive is heated to soften the adhesive. Then, the under surface of the artificial turf is pressed into contact with the softened adhesive. When the adhesive cools, the two adjacent strips of artificial turf are bonded to the seaming tape thereby holding the two pieces of turf together at the edges thereof which forms a butt seam.

U.S. Pat. No. 9,631,327 (the disclosure of which is incorporated herein by reference) discloses a typical process for butt seaming artificial turf using a conventional pressure sensitive, hot melt adhesive coated seaming tape. Hot melt adhesives typically used seaming tape for artificial turf typically includes a composite of paper (carrier for the adhesive), the adhesive and a woven material (optional) embedded in the adhesive.

The recyclability of artificial turf is a significant issue. Due the incompatibilities between the face fiber, the primary backing material, the precoat adhesive and the hot met adhesive of the seaming tape usually results in the inability to recycle artificial turf. As a result, artificial turf frequently ends up in a landfill. Furthermore, the use of hot melt adhesives to seam artificial turf may be subject to weather condition such that hot weather may soften the hot melt adhesive after seaming, thereby rendering the seam subject to failure. This can cause significant delays in the installation of artificial turf, which also translated into increased costs.

It would be desirable to provide an efficient, relatively inexpensive and relatively simple method of butt seaming artificial turf. It would also be desirable to provide a method of butt seaming artificial turf that is completely recyclable. Additionally, it would also be desirable to provide a method of butt seaming artificial turf that can be used in a wide variety of weather conditions.

### SUMMARY OF THE INVENTION

The present invention satisfies the foregoing needs by providing an improved artificial turf and an improved method of seaming artificial turf.

In one disclosed embodiment, the present invention comprises a method. The method comprises providing a piece of artificial turf comprising a primary backing material having an upper surface and a lower surface, a plurality of tufts of filament material formed in the primary backing material, wherein the tufts are arranged to simulate blades of grass extending outwardly from the upper surface of the primary backing material and the tufts have tuft backs formed on the lower surface of the primary backing material and a layer of a thermoplastic polymer formed on the lower surface of the primary backing material and the tuft backs such that the layer of thermoplastic polymer attaches the tuft backs to the primary backing material. The method further comprises heating a portion of the layer of thermoplastic polymer adjacent an edge of the artificial turf until the portion of the layer of thermoplastic polymer softens or melts and pressing the softened or melted portion of the layer of thermoplastic polymer into contact with a seaming tape.

In another disclosed embodiments, the present invention comprises positioning artificial turf on a support surface, the artificial turf comprising a primary backing material having an upper surface and a lower surface, a plurality of tufts of filament material formed in the primary backing material, wherein the tufts are arranged to simulate blades of grass extending outwardly from the upper surface of the primary backing material and the tufts have tuft backs formed on the lower surface of the primary backing material and a layer of a thermoplastic polymer formed on the lower surface of the primary backing material and the tuft backs such that the layer of thermoplastic polymer attaches the tuft backs to the primary backing material. The method also comprises positioning an elongate piece of seaming tape under an edge of the artificial turf, heating a portion of the layer of thermoplastic polymer adjacent the edge of artificial turf until the portion of the layer of thermoplastic polymer softens or melts and pressing the softened or melted portion of the layer of thermoplastic polymer into contact with the seaming tape.

In another disclosed embodiment, the present invention comprises providing two strips of artificial turf each strip having a straight edge and comprising a primary backing material having an upper surface and a lower surface, wherein the primary backing material is made from a thermoplastic polymer material, a plurality of tufts of filament material formed in the primary backing material, wherein the tufts are arranged to simulate blades of grass extending outwardly from the upper surface of the primary backing material and the tufts have tuft backs formed on the lower surface of the primary backing material wherein the tufts of material are made from a thermoplastic polymer material and a layer of a thermoplastic polymer formed on the lower surface of the primary backing material and the tuft backs such that the layer of thermoplastic polymer attaches the tuft backs to the primary backing material. The method further comprises providing an elongate piece of seaming tape having a first surface and an opposite second surface and positioning the first surface on a support surface and positioning a first strip and a second strips of the artificial turf on the support surface edge-to-edge. The method also comprises positioning the first strip of artificial turf on the support surface such that at least a portion of the first strip is disposed on the elongate piece of seaming tape and such that the layer of thermoplastic polymer directly contacts the second surface of the elongate piece of seaming tape and positioning the second strip of artificial turf on the support surface such that at least a portion of the second strip is disposed on the elongate piece of seaming tape and such that the layer of thermoplastic polymer contacts the second surface of the elongate piece of seaming tape, whereby a butt seam is formed between the first and second strips of artificial turf and the butt seam is disposed on the elongate piece of seaming tape. Additionally, the method comprises heating portions of the layer of thermoplastic polymer adjacent each of the edges of the first and second strips of artificial turf until the portions of the layer of thermoplastic polymer are softened or melted, positioning the edges of the first and second strips of artificial turf adjacent each other, pressing the softened or melted portion of the layer of thermoplastic polymer on the first and second strips of artificial turf into contact with the second surface of the elongate piece of seaming tape and allowing the softened or melted portions of the layer of thermoplastic polymer to cool, whereby the seaming tape is adhered to the lower surface of the first and second strips of artificial turf.

Accordingly, it is an object of the present invention to provide an improved artificial turf and an improved method of butt seaming artificial turf.

Another object of the present invention is to provide an artificial turf that is completely recyclable.

A further object of the present invention is to provide a method of butt seaming artificial turf that can be performed in a variety of weather conditions.

Still another object of the present invention is to provide a method of butt seaming artificial turf that is relatively easy and inexpensive.

These and other objects, features and advantages of the present invention will become apparent after a review of the following detailed description of the disclosed embodiments and the appended claims.

### BRIEF DESCRIPTION OF THE DRAWINGS

FIG. 1 is a perspective view of a disclosed embodiment of a seaming apparatus for use in the present invention.

FIG. 2 is a cross-sectional schematic view of a disclosed embodiment of tufted artificial turf in accordance with the present invention.

FIG. 3 is a partial perspective view of the seaming apparatus shown in FIG. 1 being used to form a butt seam for artificial turf.

FIG. 4 is a top plan schematic view of a disclosed embodiment of butt joined artificial turf for seaming in accordance with the present invention.

FIG. 5 is a cross-sectional schematic side view of a disclosed embodiment of the seaming material in accordance with the present invention.

FIG. 6 is a partial cross-sectional end view of the butt joined artificial turf shown in FIG. 4 taken along the line 6-6, schematically showing a heating tool in accordance with the present invention.

FIG. 7 is a partial cross-sectional end view of the butt joined artificial turf shown in FIG. 2 taken along the line 7-7, schematically showing a heating tool in accordance with the present invention.

FIG. 8 is a top plan partial detail view of a disclosed embodiments of a nozzle for use in the seaming apparatus shown in FIG. 1.

FIG. 9 is a partial perspective view of a hot air nozzle and roller weight for use in the seaming apparatus shown in FIG. 1.

### DETAILED DESCRIPTION OF THE DISCLOSED EMBODIMENTS

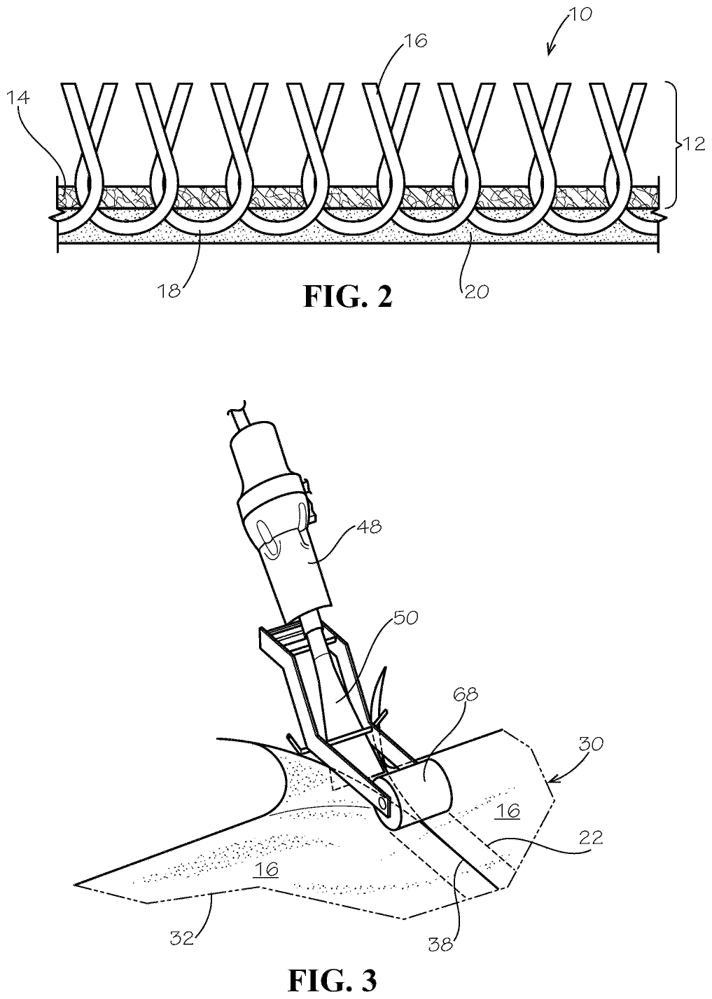

The present invention relates to a method for seaming artificial turf 10 (FIG. 2). The artificial turf 10 comprises tufted greige goods 12 comprise a synthetic primary backing material 14 and tufted synthetic yarns or filaments that form a face pile 16 on one side of the primary backing material and tuft backs 18 on the other side of the primary backing material. The face pile 16 can be either looped pile or cut pile, but most artificial turf is cut pile, individual filaments or filament bundles. The primary backing material 14 can be woven or nonwoven. Both the face pile 16 and the primary backing material 14 can be made from natural or synthetic materials; however, it is preferred that the face pile and primary backing material be made from thermoplastic materials that can be recycled. Suitable thermoplastic materials for the face pile 16 and primary backing material 14 include, but are not limited to, nylon, including polyadipamide, polycaprolactam, copolymers, or blends thereof; polyolefin, including polyethylene, polypropylene, copolymers or blends thereof; thermoplastic polyester, including polytrimethylene terephthlate or polyethylene terephthalate, or blends thereof; acrylics, including polyacrylonitrile; co-polymers or blends thereof. A preferred material for the face pile 16 is polyethylene. Preferred materials for the primary backing material 14 are polypropylene or polyester. An especially preferred material for the face pile 16 is polyethylene and for the primary backing material 16 is polypropylene.

The tuft backs 18 of the yarns or filaments that form the face pile 16 are locked in place by a layer of precoat adhesive 20. The precoat adhesive 20 is preferably made from a thermoplastic polymer material. It is more preferred that the precoat adhesive 20 is made from a thermoplastic polymer material that is compatibly recyclable with the material from which the tufted greige goods 12 is made. It is especially preferred that the tufted greige goods 12 and the precoat adhesive 20 be made from a thermoplastic polymer material so that the artificial turf is 100% recyclable. It is preferred that the precoat adhesive 20 is made from a thermoplastic polymer, copolymer or a mixture thereof, such as polypropylene or polyethylene, particularly low-density polyethylene (LDPE). It is particularly preferred that the face pile is made from polyethylene, primary backing material 16 is made from polypropylene and that the layer of precoat adhesive 20 is made from low-density polyethylene (LDPE). Polypropylene, polyethylene and low-density polyethylene are all compatibly recyclable, meaning that any combination of those components can be recycled together; i.e., melted together to produce a new thermoplastic polymer mixture that can be reused for thermoplastic polymer applications.

The layer of precoat adhesive 20 is applied to the under surface of the primary backing material 14 at a rate of approximately 5 to approximately 20 ounces per square yard, preferably 8 to approximately 16 ounces per square yard. The layer of precoat adhesive 20 can be formed on the under surface of the primary backing material 14 by any process know in the art, such as that disclosed in U.S. Pat. No. 10,202,722 and U.S. patent application Ser. No. 15/608,334 filed May 30, 2017 (the disclosures of which are both incorporated herein by reference in their entirety).

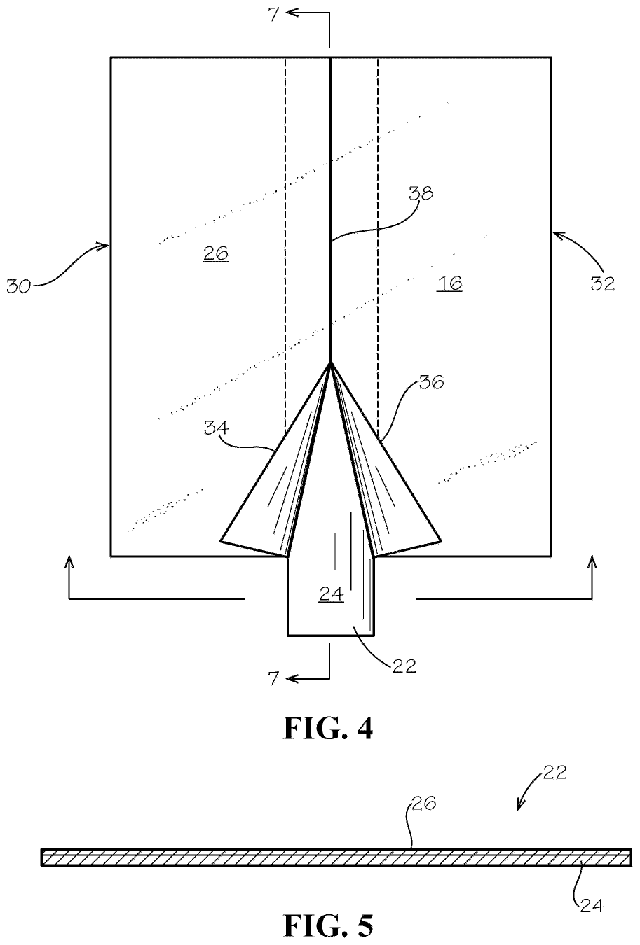

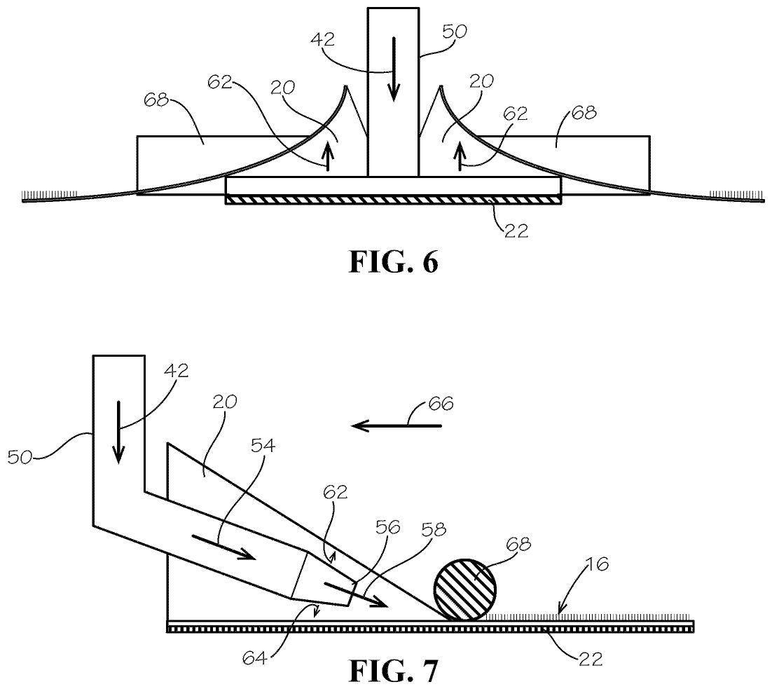

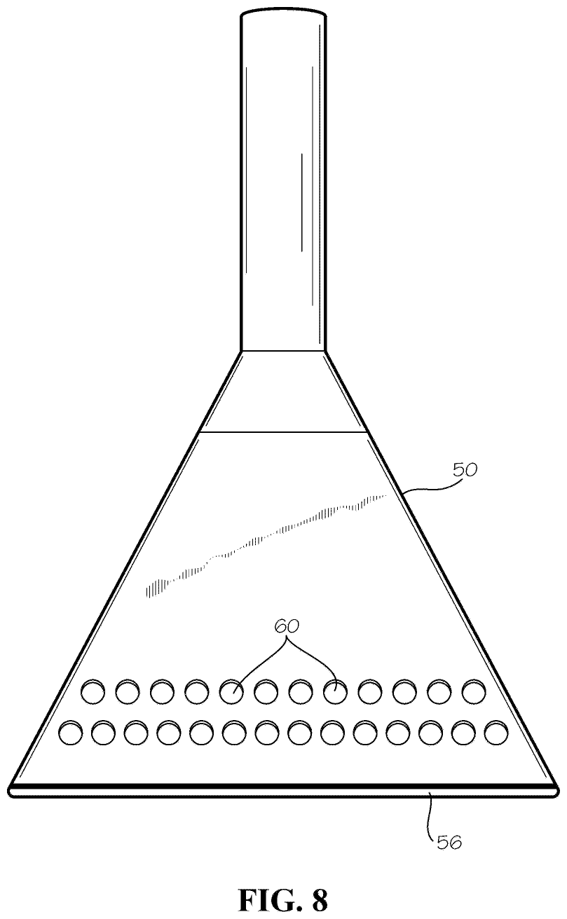

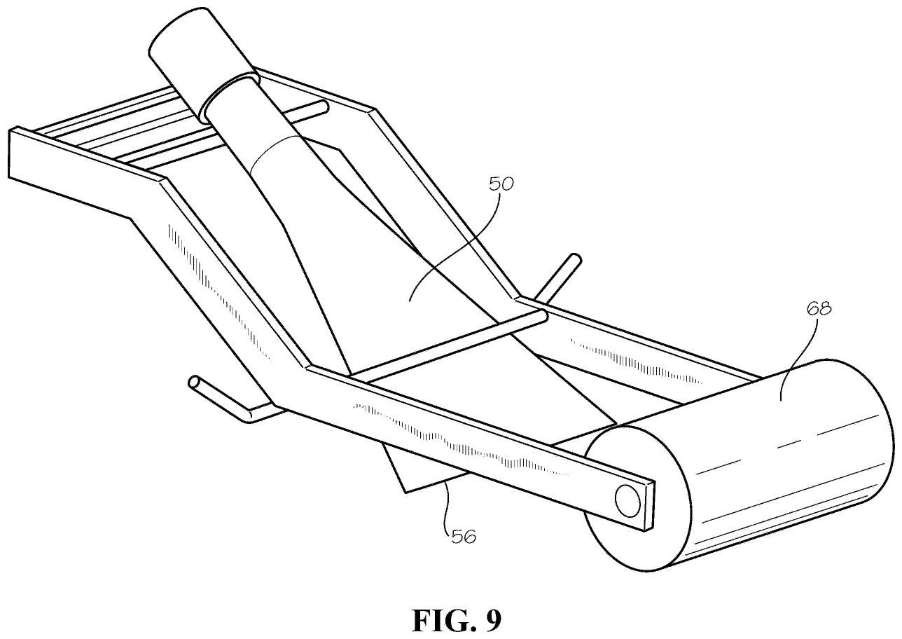

In accordance with the present invention, a seaming tape 22 (FIGS. 4-7) is used to butt seam the artificial turf 30, 32. The seaming tape 22 comprises a base layer 24 and an optional adhesive layer 26 (FIG. 5). The base layer 24 can be a woven material, a nonwoven material, a composite of two or more different materials or a combination of woven and nonwoven material, but is preferably a nonwoven material. The base layer 24 is preferably made from a thermoplastic material, such as polypropylene, polyethylene, polyethylene terephthalate (PET), nylon or low-density polyethylene (LDPE). Low density polypropylene is generally recognized as having a density of approximately 0.917 to approximately 0.930 g/cm³. The base layer 24 preferably has a weight of approximately 4 to approximately 12 ounces per square yard, especially about 4 to about 10 ounces per square yard and preferably a breaking strength of approximately 100 lbs. per 4 inches to approximately 250 lbs. per 4 inches, especially approximately 175 lbs. per 4 inches to approximately 225 lbs. per 4 inches.

The optional adhesive layer 26 is made from a thermoplastic material, such as polypropylene or polyethylene, particularly low-density polyethylene (LDPE). The adhesive layer 26 can be a continuous coating or a discontinuous coating on the base layer 24. Preferably the adhesive layer 26 comprises a coating of low-density polyethylene (LDPE) applied to the base layer 24 at the rate of approximately 3 ounces per square yard. This coating layer 26 on the tape fabric base layer 24 is preferably applied in a sintering process rather than a true melting process. As stated above, the adhesive layer 26 is optional.

In a particularly preferred disclosed embodiment of the present invention, the seaming tape 22 is comprised of the base layer 24 without the adhesive layer 26 (FIGS. 4, 6 and 7). This embodiment provides unexpected results in that the adhesive layer on the seaming tape is not required while still obtaining the desired bonding strength required for butt seaming artificial turf with the bonding coming from the layer of precoat adhesive 20 as described further below.

To butt seam artificial turf in accordance with the present invention, two pieces or strips of artificial turf 30, 32 identical to the artificial turf 10 are positioned on the ground or support surface adjacent each other (FIG. 2). An edge 34 of the artificial turf 30 is positioned adjacent to a butting against an edge 36 of the artificial turf 32. The two pieces of artificial turf 30, 32 are position with the face pile 16 facing upwardly (FIGS. 2, 4 and 5). The edges 34, 36 form a seam 38 between the two strips of artificial turf 30, 32. Positioned below the seam 38 is the seaming tape 22. If the seaming tape 22 includes the adhesive layer 26, the seaming tape is positioned so that the adhesive layer 26 faces upwardly and is adjacent the precoat adhesive 20 on the artificial turf 30, 32. If no adhesive layer 26 is present on the base layer 24, the seaming tape 22 can be positioned in any orientation as both surfaces are identical. The seaming tape 22 extends longitudinally so that a portion of the seaming tape underlies the artificial turf 30 and the other portion of the seaming tape extends under the artificial turf 32 (FIG. 4). Furthermore, the seam 38 between the two strips of artificial turf 30, 32 overlays the approximate center line of the seaming tape 22. The seaming tape 22 is preferably approximately 4 to 12 inches wide, more preferably approximately 6 inches wide.

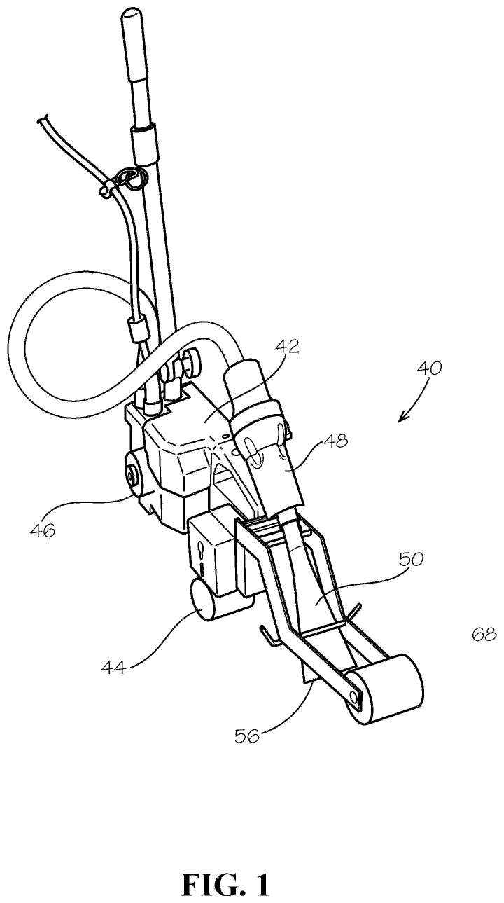

An objective of the present invention is to form a melt bond between the layer of precoat adhesive 20 of each of the strips of artificial turf 30, 32 and the seaming tape 22. This is done by applying heat to the layer of precoat adhesive 20 of each of the strips of artificial turf 30, 32. Alternatively, if the seaming tape includes an adhesive layer 26, both the adhesive layer and the layer of precoat adhesive 20 are both heated. This is preferably done by directing a flow of hot air toward the layer of precoat adhesive 20 and the base layer 24 (or the layer of precoat adhesive 20 and the adhesive layer 26). This can be done manually with a hot air gun, such as the Leister Triac AT, or with an automated hot air machine, such as the Leister Uniroof AT/ST available from Leister Technologies AG, Kaegiswil, Switzerland. A modified automated hot air gun assembly 40 suitable for use in the present invention is shown in FIG. 1.

The automated hot air gun assembly 40 includes a cart 42 supported on a plurality of rotatable wheels 44, 46. The automated hot air gun assembly also includes a hot air gun 48. The cart 42 includes motors (not shown) for driving the wheels 44, 46 and a power supply (not shown) for providing electricity to the hot air gun 48. The hot air gun 48 includes electric heating elements (not shown) for heating air in the gun and a fan (not shown) for expelling the heated air out of the gun. The hot air gun 48 is fitted with a nozzle 50 that channels hot air from the hot air gun, such as shown by the arrows 52, 54, to a slot 56 formed in the end of the nozzle. The slot 56 is preferably the same width as the width of the seaming tape 22, so that it can be heated in a single pass. Of course, a narrower nozzle can also be used and the turf seamed in two passes, one pass for each of the pieces of artificial turf 30, 32. The heated air that exits the slot 56, such as shown by the arrow 58, and is directed toward the conjunction of the artificial turf 30, 32 and the seaming tape 22, more particularly toward a portion if the layer of precoat adhesive 20 adjacent the edges 34, 36 of the strips of artificial turf (and optionally the adhesive layer 26). The heated air that exits the slot 46 is sufficiently hot such that it melts or softens the portion of the precoat adhesive 20 adjacent the edges 34, 36 (and optionally the adhesive layer 26). When the layer of precoat adhesive 20 (and optionally the adhesive layer 26) is both made from low-density polyethylene (LDPE), it will melt or soften at approximately 235° F. Therefore, it is preferred that the air exiting the slot 56 of the nozzle 50 is approximately 235 to approximately 500° F. Optionally, the nozzle 50 can include a plurality of holes 60 formed in the top and bottom of the nozzle adjacent the slot 46. When the nozzle 50 is provided with such holes 60, heated air will exit the nozzle at the top and the bottom thereof, such as shown by the arrows 62, 64 (FIG. 7), so as to preheat the layer of precoat adhesive 20 and seaming tape 20 (and optionally the adhesive layer 26) so that the heated air from the slot 56 can more quickly melt or soften the layer of precoat adhesive and preheat the seaming tape 22 (and optionally the adhesive layer 26). The nozzle 50 is moved in the direction shown by the arrow 66 (FIG. 7). After the nozzle 50 heats the portion of the layer of precoat adhesive 20 (and optionally the adhesive layer 26) to the desired temperature, the melted or softened layer of precoat adhesive is brought into intimate contact with the seaming tape 22; i.e., either the base layer 24 by itself or with the adhesive layer 26, so that the melted or softened precoat adhesive and the base layer 24 (or optionally the adhesive layer 26) fuse together to form a bond therebetween. To facilitate this intimate contact, a weighted roller 68 sits atop the face pile 16 side of the artificial turf 30, 32 and presses downwardly, thereby compressing the precoat adhesive and seaming tape 22 (either the base layer 24 or the adhesive layer 26).

The automated hot air gun assembly 40 is used by initially lifting upwardly the edges of the edges 34, 36 of the strips of artificial turf 30, 32, respectively, as shown in FIGS. 3, 4, 6 and 7. The nozzle 50 is positioned so that the slot 56 directs the heated air to the interface between the layer of thermoplastic polymer 20 on the two strips of artificial turf 30, 32 and the seaming tape 22 (either the base layer 24 by itself or the layer of adhesive 26) as shown in FIGS. 3, 6 and 7). The roller 68 is positioned on top of the face pile 16 of the two strips of artificial turf 30, 32 so that it presses down on the strips of artificial turf.

The roller 68 is moved in the direction of the arrow 66 and in concert with the movement of the nozzle 50 so that they both move together. Such movement can be done manually, but is preferably done with the automated hot air gun assembly 40 which can be programmed for a desired speed of movement. The speed at which the automated hot air gun assembly 40 moves can be adjusted so that a sufficient amount of heated air is applied to the precoat adhesive 20 (and optionally the adhesive layer 26) such that a strong weld is created while also maximizing the speed at which the apparatus travels. Obviously, the faster the automated hot air gun assembly 40 moves, the quicker the butt seam is accomplished which reduces the amount of labor required to perform this seaming process. This reduces the amount of labor and saves significantly on the cost of installation of artificial turf Also, the method of the present invention is less subject to weather variations and does not lose strength when wet.

The following examples are illustrative of selected embodiments of the present invention and are not intended to limit the scope of the invention as set forth in the appended claims.

### EXAMPLE 1

A synthetic turf product is prepared in accordance with the present invention. The turf comprises a 2.5 inch pile height polyethylene face fiber tufted into a single woven polypropylene primary backing or double woven primary baking. A precoat adhesive layer is formed on the back of the primary backing and the tuft backs. The precoat adhesive layer is made from low-density polyethylene. A 6 inches wide strip of seaming tape is prepared with a base layer and an adhesive layer of low-density polyethylene formed on the top surface thereof. Two strips of the artificial turf are butt seamed in accordance with the process described above using seaming tape of various compositions and also using a sewn seam as further described below.

Seam breaking strength for the synthetic turf is tested. ASTM D3054 is used in the US while test methods En12228-1 and En12228-2 are the accepted FiFa test methods. A stitched seam, dry or wet, must meet a minimum of 225 lbs. per 4 inch length while a bonded seam, dry or wet, must have a minimum of 17 lbs. per 4 inch length. The delamination strength of some samples is also tested for peel or stripping strength in accordance with ASTM D903.

A synthetic turf as described above having two primaries is tested for break strength (no seam). The synthetic turf has a layer of precoat adhesive of low-density polyethylene at a coating weight of 16 ounces per square yard. The synthetic turf has a break strength of 303 lbs. per 4 inches as measured in accordance with ASTM D3054.

### EXAMPLE 2

The synthetic turf product of Example 1 is used, except that it includes a single primary backing. This test is performed to measure the strength of sewn seams. Two strips of synthetic turf are sewn together using Union Special 81500B sewing machine with no-cut selvages. The test produces a seam break strength of 267 lbs. per 4 inches. The same strips of synthetic turf are sewn together using Union Special 81500B sewing machine with cut selvages (sewn into the turf fabric) was 20 lbs per 4 inches.

### EXAMPLE 3

The synthetic turf product of Example 2 is used. This test is performed to measure the strength of a seam using a seaming tape in the process of the present invention. The seaming tape utilizes a base layer of AD 100 from Low and Bonar of London, England. The AD 100 is a 4 ounce per square yard nylon skin/polyester core spun laid and thermally bonded nonwoven product. The AD 100 has a break strength of 50 lbs. per 2 inches as tested in accordance with ISO 907-3. The AD 100 included a pre-applied adhesive layer made from low-density polyethylene at a rate of 3 ounces per square yard. The test produces a seam break strength of 129 lbs. per 4 inches. Another test using identical synthetic turf but using seaming tape utilizing a base layer of WHD 150 from Low and Bonar. The WHD 150 is a 6 ounce per square yard of a nylon skin/polyester core spun laid and thermally bonded nonwoven product. The same pre-applied adhesive layer is used with the AD 150. The test produces a seam break strength of 132 lbs. per 4 inches. The results of these two tests were similar even though the break strength of the AD 100 and the WHD 150 were substantially different.

### EXAMPLE 4

The synthetic turf product of Example 2 is used. This test is performed to measure the strength of a seam using a seaming tape in the process of the present invention. The seaming tape utilizes a base layer from Mapei Fabric of Deerfield Beach, Fla. The base layer is an 8 ounce per square yard polyethylene terephthalate (PET) point bonded product. The seaming tape includes a pre-applied adhesive layer made from low-density polyethylene at a rate of 3 ounces per square yard. The synthetic turf seam with the Mapei Fabric seaming tape has a break strength of 200 lbs. per 4 inches as measure in accordance with ASTM D5034.

### EXAMPLE 5

The synthetic turf product and WHD 150 seaming tape of Example 3 is used. This test is performed to test the dry versus wet break strength. The dry break strength for WHD 150 is 188 lbs. per 4 inches. The wet break strength for the WHD 150 is 185 lbs. per 4 inches.

### EXAMPLE 6

The synthetic turf product and Mapei Fabric seaming tape of Example 3 is used, except the seaming tape did not include the adhesive layer; it was just the base layer with no adhesive. The test produces a seam break strength of 216 lbs. per 4 inches.

### EXAMPLE 7

The synthetic turf product and WHD 150 seaming tape of Example 3 is used, except the seaming tape did not include the adhesive layer; it was just the base layer with no adhesive. The test produces a seam break strength of 208 lbs. per 4 inches.

Examples 6 and 7 show unexpected results in that the seaming tapes without the adhesive layer 26 produce results as good as or better that the test results of the seaming tape with the adhesive layer. Additionally, the test samples show that the breaking strength point is not at the actual seam. On both test samples, the synthetic turf itself ruptured just past the seam while the seams stayed together. It is therefore concluded that the turf seam of the present invention is stronger than the primary in the turf.

It should be understood, of course, that the foregoing relates only to certain disclosed embodiments of the present invention and that numerous modifications or alterations may be made therein without departing from the spirit and scope of the invention.

What is claimed is:

1. A method of seaming artificial turf comprising:
providing two strips of artificial turf each strip having a straight edge and comprising:
a primary backing material having an upper surface and a lower surface, wherein the primary backing material is made from a thermoplastic polymer material;
a plurality of tufts of filament material formed in the primary backing material, wherein the tufts are arranged to simulate blades of grass extending outwardly from the upper surface of the primary backing material and the tufts have tuft backs formed on the lower surface of the primary backing material wherein the tufts of material are made from a thermoplastic polymer material; and
a layer of a thermoplastic polymer formed on the lower surface of the primary backing material and the tuft backs such that the layer of thermoplastic polymer attaches the tuft backs to the primary backing material; and
providing an elongate piece of seaming tape having a first surface and an opposite second surface and positioning the first surface on a support surface wherein the seaming tape is made from a thermoplastic polymer material;
positioning a first strip and a second strips of artificial turf on the support surface edge-to-edge;
positioning the first strip of artificial turf on the support surface such that at least a portion of the first strip is disposed on the elongate piece of seaming tape and such that the layer of thermoplastic polymer directly contacts the second surface of the elongate piece of seaming tape;
positioning the second strip of artificial turf on the support surface such that at least a portion of the second strip is disposed on the elongate piece of seaming tape and such that the layer of thermoplastic polymer contacts the second surface of the elongate piece of seaming tape, whereby a butt seam is formed between the first and second strips of artificial turf and the butt seam is disposed on the elongate piece of seaming tape;
heating portions of the layer of thermoplastic polymer adjacent each of the edges of the first and second strips of artificial turf until the portions of the layer of thermoplastic polymer are softened or melted;
positioning the edges of the first and second strips of artificial turf adjacent each other;
pressing the softened or melted portion of the layer of thermoplastic polymer on the first and second strips of artificial turf into contact with the second surface of the elongate piece of seaming tape; and
allowing the softened or melted portions of the layer of thermoplastic polymer to cool, whereby the seaming tape is adhered to the lower surface of the first and second strips of artificial turf.

2. The method of seaming artificial turf of claim 1, wherein the layer of thermoplastic polymer material is heated with heated air.

3. The method of claim 1, wherein the tufts of filament material, the primary backing material, the seaming tape and the layer of thermoplastic polymer are all made from compatibly recyclable material.

4. The method of claim 1, wherein the tufts of filament material, the primary backing material, the seaming tape and the layer of thermoplastic polymer are made from nylon, polyethylene, polypropylene, thermoplastic polyester, acrylics or co-polymers or blends thereof.

5. The method of claim 1, wherein the tufts of filament material are made from polyethylene, the primary backing material is made from polypropylene, and the layer of thermoplastic polymer is made from polyethylene.

6. The method of claim 5, wherein the layer of thermoplastic polymer is made from low-density polyethylene.

7. The method of claim 7, wherein the seaming tape is made from a nonwoven fabric.

8. The method of claim 7, wherein the nonwoven fabric is made from a composite fabric of nylon and polyester.

9. A method comprising:
positioning artificial turf on a support surface, the artificial turf comprising:
a primary backing material having an upper surface and a lower surface;
a plurality of tufts of filament material formed in the primary backing material, wherein the tufts are arranged to simulate blades of grass extending outwardly from the upper surface of the primary backing material and the tufts have tuft backs formed on the lower surface of the primary backing material; and
a layer of a thermoplastic polymer formed on the lower surface of the primary backing material and the tuft backs such that the layer of thermoplastic polymer attaches the tuft backs to the primary backing material;
positioning an elongate piece of seaming tape under an edge of the artificial turf;
heating a portion of the layer of thermoplastic polymer adjacent the edge of artificial turf until the portion of the layer of thermoplastic polymer softens or melts;
pressing the softened or melted portion of the layer of thermoplastic polymer into contact with the seaming tape.

10. The method of seaming artificial turf of claim 9, wherein the layer of thermoplastic polymer material is heated with heated air.

11. The method of claim 9, wherein the tufts of filament material, the primary backing material, the seaming tape and the layer of thermoplastic polymer are all made from compatibly recyclable material.

12. The method of claim 9, wherein the tufts of filament material, the primary backing material, the seaming tape and the layer of thermoplastic polymer are made from nylon, polyethylene, polypropylene, thermoplastic polyester, acrylics or co-polymers or blends thereof.

13. The method of claim 9, wherein the tufts of filament material are made from polyethylene, the primary backing material is made from polypropylene, and the layer of thermoplastic polymer is made from polyethylene.

14. The method of claim 13, wherein the layer of thermoplastic polymer is made from low-density polyethylene.

15. The method of claim 14, wherein the seaming tape is made from a nonwoven fabric.

16. The method of claim 15, wherein the nonwoven fabric is made from a composite fabric of nylon and polyester.

17. A method comprising:
providing a piece of artificial turf comprising:
a primary backing material having an upper surface and a lower surface;
a plurality of tufts of filament material formed in the primary backing material, wherein the tufts are arranged to simulate blades of grass extending outwardly from the upper surface of the primary backing material and the tufts have tuft backs formed on the lower surface of the primary backing material; and
a layer of a thermoplastic polymer formed on the lower surface of the primary backing material and the tuft backs such that the layer of thermoplastic polymer attaches the tuft backs to the primary backing material;
heating a portion of the layer of thermoplastic polymer adjacent an edge of the artificial turf until the portion of the layer of thermoplastic polymer softens or melts; and
pressing the softened portion of the layer of thermoplastic polymer into contact with a seaming tape.

18. The method of seaming artificial turf of claim 17, wherein the layer of thermoplastic polymer material is heated with heated air.

19. The method of claim 17, wherein the tufts of filament material, the primary backing material, the seaming tape and the layer of thermoplastic polymer are all made from compatibly recyclable material.

20. The method of claim 17, wherein the tufts of filament material, the primary backing material, the seaming tape and the layer of thermoplastic polymer are made from nylon, polyethylene, polypropylene, thermoplastic polyester, acrylics or co-polymers or blends thereof.

21. The method of claim 20, wherein the tufts of filament material are made from polyethylene, the primary backing material is made from polypropylene, and the layer of thermoplastic polymer is made from polyethylene.

22. The method of claim 21, wherein the layer of thermoplastic polymer is made from low-density polyethylene.

23. The method of claim 22, wherein the seaming tape is made from a nonwoven fabric.

24. The method of claim 23, wherein the nonwoven fabric is made from a composite fabric of nylon and polyester.
